(19) United States
(12) Patent Application Publication
(10) Pub. No.: US 2012/0005507 A1
(43) Pub. Date: Jan. 5, 2012

(54) Display Devices and Control Methods

(75) Inventors: Chi-Shiung Lin, Sinshih Township (TW); Chih-Yang Liao, Sinshih Township (TW)

(73) Assignee: HIMAX TECHNOLOGIES LIMITED, Sinshih Township (TW)

(21) Appl. No.: 12/828,356

(22) Filed: Jul. 1, 2010

(51) Int. Cl. G06F 12/00; G06F 1/32

(52) U.S. Cl. 713/323; 711/154; 711/104; 711/E12.001

(57) ABSTRACT

A display device includes a host, a control unit, and a display unit. The control unit receives host data from the host and then generates input data. The control unit includes first, second, and third memories and an arbiter. The first memory stores the input data to serve as first stored data. The second memory stores second stored data and outputs it for generating output data. The third memory stores third stored data. When the amount of the first stored data is greater than a first threshold value, the arbiter performs a writing operation to write the first stored data into the third memory. When the amount of the second stored data is lower than a second threshold value, the arbiter performs a reading operation to read the third stored data to being written into the second memory. The display unit displays images according to the output data.

### BACKGROUND OF THE INVENTION

1. Field of the Invention

The invention relates to a display device, and more particularly to a control method for controlling a display device.

2. Description of the Related Art

In current electro-phoretic display (EPD) devices, after a host finishes transmitting host data to a control unit, the control unit then transmits corresponding image data to a display panel. Only after the display panel finishes displaying an image according to the transmitted image data, then the host can start to transmit the next host data related the next image to the control unit. Thus, EPD devices have low operating efficiency when displaying images.

Thus, it is desired to provide a control unit for an EPD device which can receive host data from a host of the EPD device when a display panel of the EPD device is displaying an image.

### BRIEF SUMMARY OF THE INVENTION

An exemplary embodiment of a display device comprises a host, a control unit, and a display unit. The host generates host data. The control unit receives the host data and generates input data according to the host data. The control unit comprises a first memory, a second memory, a third memory, and an arbiter. The first memory receives and stores the input data to serve as first stored data. The second memory stores second stored data and outputs the second stored data for generating output data. The third memory stores third stored data. The arbiter performs a writing operation to the third memory according to an amount of the first stored data in the first memory or performs a reading operation to the third memory according to an amount of the second stored data in the second memory. When the amount of the first stored data in the first memory is greater than a first threshold value, the arbiter performs a writing operation to write the first stored data from the first memory into the third memory to serve as the third stored data. When the amount of the second stored data in the second memory is lower than a second threshold value, the arbiter performs a reading operation to read the third stored data from the third memory, and the third stored data is written into the second memory to serve as the second stored data. The display unit receives the output data from the control unit and displays images according to the output data.

An exemplary embodiment of a control method is provided to control a first memory which stores first stored data for displaying images. The control method comprises the steps of determining whether a writing operation or a reading operation is performed to the first memory; when the writing operation is performed to the first memory, writing second stored data in a second memory into the first memory to serve as the first stored data; and when the reading operation is performed to the first memory, reading the first stored data from the first memory for displaying images.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 shows an exemplary embodiment of a display device;

FIG. 2 shows an exemplary embodiment of the control unit in FIG. 1; and

FIG. 3 shows a flow chart of an exemplary embodiment of a control method for controlling the SDRAM in FIG. 1.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

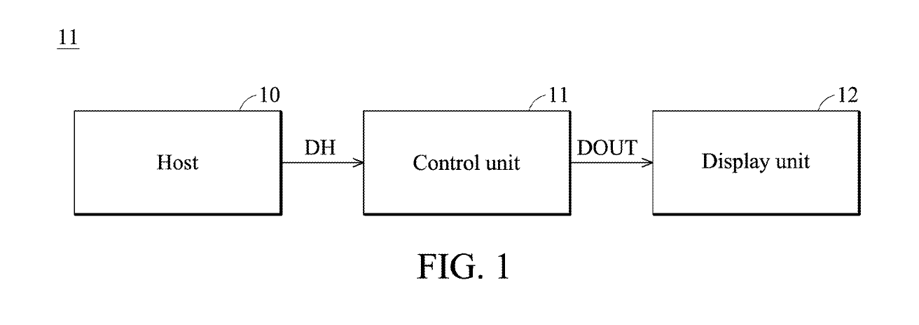

Display devices are provided. In an exemplary embodiment of a display device in FIG. 1, a display device 1 comprises a host 10, a control unit 11, and a display unit 12. In the embodiment, the display device 1 can be an electro-phoretic display (EPD) device. The host 10 transmits host data DH to the control unit 11. The control unit 11 generates output data DOUT according to the host data DH and transmits the output data DOUT to the display unit 12 for displaying images. According to the embodiment, when the control unit 11 is transmitting the output data DOUT to the display unit 12, the host 10 can transmit the host data DH to the control unit 11 at the same time. For example, when the control unit 11 is transmitting the output data DOUT related to a current image to the display unit 12 for display, the host 10 can transmit the host data DH related to the next image to the control unit 11 at the same time. Thus, the host 10 can transmit the host data related to the next image in real-time without waiting for the display unit 12 to finish displaying the current image.

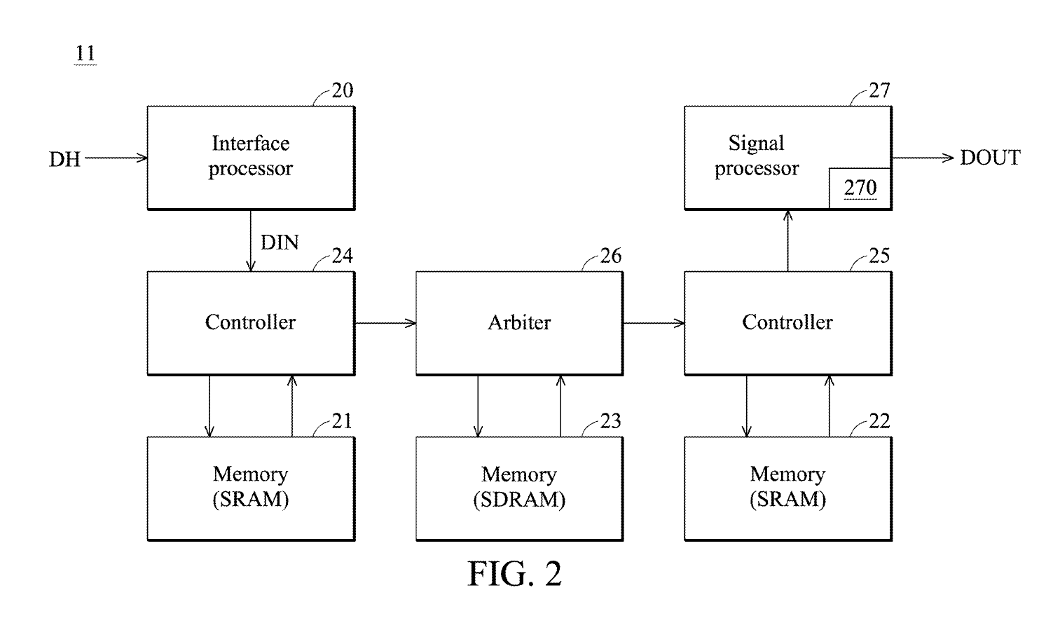

FIG. 2 shows an exemplary embodiment of the control unit 11. As shown in FIG. 2, the control unit 11 comprises an interface processor 20, memories 21, 22, and 23, controllers 24 and 25, an arbiter 26, and a signal processor 27. In the embodiment, the memories 21 and 22 are implemented by SRAMs, and the memory 23 is implemented by an SDRAM. The controllers 24 and 25 are used to control the SRAMs 21 and 22 respectively. The arbiter 26 is used to control the SDRAM 23 and determines whether a writing operation or a reading operation is performed to the SDRAM 23. The SRAM 21 stores input data DIN from the interface processor 20. The SDRAM 23 stores the data from the SRAM 21. The SRAM 22 stores data from the SDRAM 23. The interface processor 20 receives the host data DH from the host 10 and changes the clock domain of the host data DH. After the changing of the clock domain of the host data DH for synchronization, the interface processor 20 generates input data DIN to the controller 24. The controller 24 writes the input data DIN from the interface processor 20 into the SRAM 21.

In the embodiment, the controller 24 can further determine the amount of the data stored in the SRAM 21. When the controller 24 determines that the amount of data stored in the SRAM 21 is greater than a first threshold value, the controller 24 reads the data from the SRAM 21 and outputs the data to the arbiter 26. At this time, the arbiter 26 determines that a writing operation is performed to the SDRAM 23. Thus, the arbiter 26 performs the writing operation to the SDRAM 23 to write the data from the SRAM 21 into the SDRAM 23.

In the embodiment, the controller 25 can further determine the amount of the data stored in the SRAM 22. The controller 25 reads and outputs the data stored in the SRAM 22 to the signal processor 27. The signal processor 27 generates the output data DOUT to the display unit 12 according to the data from the SRAM 22, and a display panel of the display unit 12 displays an image according to the output data DOUT. In the embodiment, the signal processor 27 comprises a look-up table 270. The signal processor 27 looks up the look-up table 270 according to the data from the SRAM 22 to find a corresponding gray level which is represented by the output data DOUT. When the controller 25 determines that the amount of data stored in the SRAM 22 is lower than a second threshold value, the arbiter 26 determines that a reading operation is performed to the SDRAM 23. Thus, the arbiter 26 performs a reading operation to the SDRAM 23 to read the data from the SDRAM 23. At this time, the controller 25 receives the data of the SDRAM 23 from the arbiter 26 and writes the data into the SRAM 23.

According to the embodiment, there are two SRAMs 21 and 22. Thus, when the control unit 11 is transmitting the output data DOUT related to a current image to the display unit 12 for display, the host 10 can transmit the host data DH related to the next image to the control unit 11, which enhances operating efficiency for displaying images.

In the embodiment, the memory 23 is implemented by an SDRAM. Thus, the arbiter 26 further determines whether a refresh operation is performed to the SDRAM 23. When the arbiter 26 determines that a refresh operation is performed to the SDRAM 23, the arbiter 26 pre-charges the SDRAM 23 to refresh the SDRAM 23, so that the data originally stored in the SDRAM 23 can be kept. In some embodiments, if the memory 23 is implemented by other memory devices, the operation of determining a refresh operation is performed and the refresh operation are omitted.

Moreover, in some embodiments, when the arbiter 23 determines that the writing operation, the reading operation, and the refresh operation are not performed to the SDRAM 23, the arbiter 23 controls the SDRAM 23 to enter into a power-down mode to save power.

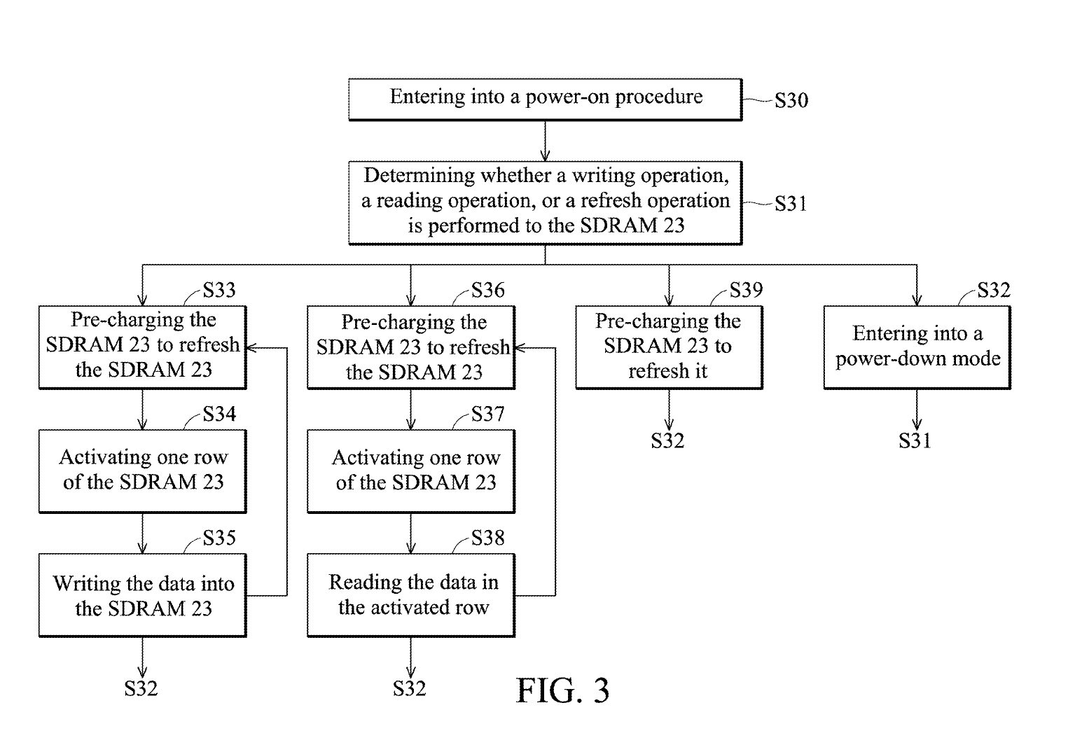

FIG. 3 shows a flow chart of an exemplary embodiment of a control method for controlling the SDRAM 23. First, the arbiter 26 controls the SDRAM 23 to enter into a power-on procedure (step S30). After the SDRAM 23 is powered on, the arbiter 26 determines whether a writing operation, a reading operation, or a refresh operation is performed to the SDRAM 23 (step S31). When the arbiter 26 determines that a writing operation, a reading operation, and a refresh operation are not performed to the SDRAM 23, the arbiter 26 controls the SDRAM 23 to enter into a power-down mode to save power (step S32). When the SDRAM 23 is reactivated, the method returns to the step S30, so that the SDRAM 23 enters into the power-on procedure again (step S30).

Referring to FIGS. 2 and 3, when the arbiter 26 determines that a writing operation is performed to the SDRAM 23 in the step S31, the arbiter 26 pre-charges the SDRAM 23 to refresh the SDRAM 23 (step S33), and the arbiter 26 activates one row of the SDRAM 23 (step S34). Then, the arbiter 26 reads the data stored in the SRAM 21 through the controller 24 and writes the data into the SDRAM 23 (step S35). If the data from the SRAM 21 is further written into another row of the SDRAM 23, the method returns to the step S33, so that the arbiter 26 can activate the row next to the activated row. When the writing operation is finished, the method returns to the step S32, so that the SDRAM 23 enters into the power-down mode.

Referring to FIGS. 2 and 3, when the arbiter 26 determines that a reading operation is performed to the SDRAM 23 in the step S31, the arbiter 26 pre-charges the SDRAM 23 to refresh the SDRAM 23 (step S36), and the arbiter 26 activates one row of the SDRAM 23 (step S37). Then, the arbiter 26 reads the data in the activated row (step S38) and writes the data into the SRAM 22 through the controller 25. If the data in the row next to the activated row is further written into the SRAM 22, the method returns to the step S36, so that the arbiter 26 can activate the row next to the activated row. When the reading operation is finished, the method returns to the step S32, so that the SDRAM 23 enters into the power-down mode (step S32).

When the arbiter 26 determines that a refresh operation is performed to the SDRAM 23 in the step S31, the arbiter 26 pre-charges the SDRAM 23 to refresh it (step S39), so that the data stored in the SDRAM 23 can be kept. When the refresh operation is finished, the method returns to the step S32.

In the embodiment, the memory 23 in FIG. 2 is implemented by an SDRAM. Thus, the pre-charging steps S33, S36, and S39 are required. In some embodiments, if the memory 23 is implemented by other memory devices, the pre-charging steps S33, S36, and S39 may be omitted. Moreover, in the step S31, the arbiter 26 only determines whether a writing operation or a reading operation is performed to the SDRAM 23 without a refresh operation.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A display device comprising:
a host for generating host data;
a control unit for receiving the host data and generating input data according to the host data, wherein the control unit comprises:
a first memory for receiving and storing the input data to serve as first stored data;
a second memory for storing second stored data and outputting the second stored data for generating output data;
a third memory for storing third stored data; and
an arbiter for performing a writing operation to the third memory according to an amount of the first stored data in the first memory or performing a reading operation to the third memory according to an amount of the second stored data in the second memory;
wherein when the amount of the first stored data in the first memory is greater than a first threshold value, the arbiter performs a writing operation to write the first stored data from the first memory into the third memory to serve as the third stored data; and
wherein when the amount of the second stored data in the second memory is lower than a second threshold value, the arbiter performs a reading operation to read the third stored data from the third memory, and the third stored data is written into the second memory to serve as the second stored data; and
a display unit for receiving the output data from the control unit and displaying

2. The display device as claimed in claim 1, wherein the control unit further comprises:
a first controller for controlling the first memory and determining the amount of first stored data in the first memory;
wherein the first controller receives the input data and writes the input data into the first memory to serve as the first stored data; and
wherein when the first controller determines that the amount of first stored data in the first memory is greater than the first threshold value, the first controller reads the first stored data from the first memory and outputs the first stored data to the arbiter.

3. The display device as claimed in claim 2, wherein the control unit further comprises:
a second controller for controlling the second memory and determining the amount of second stored data in the second memory;
wherein the second controller outputs the second stored data for generating the output data to the display unit for displaying images; and
wherein when the second controller determines that the amount of second stored data in the second memory is lower than the second threshold value, the second controller receives the third stored data from the arbiter and writes the third stored data into the second memory to serve as the second stored data.

4. The display device as claimed in claim 1, wherein the first memory is implemented by an SRAM.

5. The display device as claimed in claim 1, wherein the second memory is implemented by an SRAM.

6. The display device as claimed in claim 1, wherein the third memory is implemented by an SDRAM.

7. The display device as claimed in claim 6, wherein the arbiter further performs a refresh operation to the third memory.

8. The display device as claimed in claim 6, wherein when the arbiter does not perform the writing operation, the reading operation, and the refresh operation, the arbiter enters into a power-down mode.

9. The display device as claimed in claim 1, wherein when the arbiter does not perform the writing operation and the reading operation, the arbiter enters into a power-down mode.

10. The display device as claimed in claim 1, the control unit further comprises:
an interface processor for receiving the host data and changing a clock domain of the host data to generate the input data; and
a signal processor for receiving the second stored data from the second memory and generating the output data according to the second stored data.

11. The display device as claimed in claim 1, wherein the display device is an electro-phoretic display (EPD) device.

12. A control method for controlling a first memory which stores first stored data for displaying images, comprising:
determining whether a writing operation or a reading operation is performed to the first memory;
when the writing operation is performed to the first memory, writing second stored data in a second memory into the first memory to serve as the first stored data; and
when the reading operation is performed to the first memory, reading the first stored data from the first memory for displaying images.

13. The control method as claimed in claim 12, wherein the first stored data read from the first memory is written into a third memory to serve as third stored data, and the third stored data is output from the third memory to a display unit for displaying images.

14. The control method as claimed in claim 12, wherein the step of determining whether the writing operation or the reading operation is performed to the first memory comprises determining whether the writing operation, the reading operation, or a refresh operation is performed to the first memory.

15. The control method as claimed in claim 14 further comprising, when the writing operation, the reading operation, and the refresh operation are not performed to the first memory, controlling the first memory to enter into a power-down mode.

16. The control method as claimed in claim 12 further comprising, when the writing operation and the reading operation are not performed to the first memory, controlling the first memory to enter into a power-down mode.

17. The control method as claimed in claim 12, wherein the step of writing the second stored data in a second memory into the first memory to serve as the first stored data comprises pre-charging the first memory, activating one row of the first memory, and then writing the second stored data into the activated row of the first memory.

18. The control method as claimed in claim 12, wherein in the step of reading the first stored data from the first memory for displaying images, the first memory is pre-charged, one row of the first memory is active, and then the first stored data in the active row is read.
